(19) United States
(12) Patent Application Publication
(10) Pub. No.: US 2025/0273814 A1
(43) Pub. Date: Aug. 28, 2025

(54) SYSTEMS FOR A VEHICLE BATTERY PACK

(71) Applicant: Ford Global Technologies, LLC, Dearborn, MI (US)

(72) Inventors: Larry Wang, Nanjing (CN); Shiwu Hao, Nanjing (CN)

(21) Appl. No.: 19/009,738

(22) Filed: Jan. 3, 2025

(30) Foreign Application Priority Data
Feb. 22, 2024 (CN) 2024101994107

(51) Int. Cl. H01M 50/30; B60L 50/64; B60L 58/26; H01M 10/48; H01M 10/613; H01M 10/625; H01M 10/647; H01M 10/6554; H01M 10/658; H01M 50/209; H01M 50/271; H01M 50/289; H01M 50/507; H01M 50/516

(52) U.S. Cl. CPC H01M 50/394; B60L 50/64; B60L 58/26; H01M 10/482; H01M 10/613; H01M 10/625; H01M 10/647; H01M 10/6554; H01M 10/658; H01M 50/209; H01M 50/271; H01M 50/289; H01M 50/507; H01M 50/516; H01M 2220/20

(57) ABSTRACT

The present disclosure relates to the field of vehicles and provides a vehicle battery pack and a vehicle having the same. The vehicle battery pack includes a first battery cell, a second battery cell, and a separator located between the first battery cell and the second battery cell. The first battery cell and the second battery cell include positive and negative electrode terminals oriented towards the separator.

### CROSS REFERENCE TO RELATED APPLICATION

The present application claims priority to Chinese Patent Application No. 2024101994107 filed on Feb. 22, 2024. The entire contents of the above-listed application is hereby incorporated by reference for all purposes.

### FIELD

The present description relates generally to the field of vehicles and, more particularly, to a vehicle battery pack and a vehicle having the same.

### BACKGROUND/SUMMARY

With the continuous development of modern motor vehicle technology, the increase in the demand for longer driving ranges and the number of various electrical equipment in the vehicle will lead to the increase in the overall power demand of the vehicle. The battery pack used to provide power for the vehicle will occupy more space and will have a more complex internal structure.

The inventors of the present application recognize that there is still room for simplifying such battery packs and making their overall structure more compact.

In one example, the issues described above may be addressed by a battery pack including a first battery cell, a second battery cell, and a separator located between the first battery cell and the second battery cell, wherein the first battery cell and the second battery cell comprise positive and negative electrode terminals both oriented towards the separator.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

In order to better understand the present disclosure, reference can be made to the embodiments shown in the following drawings. The components in the drawings may not necessarily be drawn to scale, and relevant components may be omitted, or in some cases, the scale may have been enlarged to emphasize and clearly illustrate the novel features described in this disclosure. Additionally, as known in the art, system components can be arranged differently. Further in the figures, like reference numbers refer to like parts throughout the different figures.

FIG. 1 illustrates a schematic diagram of a vehicle comprising a vehicle battery pack according to one or more embodiments of the present disclosure;

FIG. 2 illustrates an exploded view of a vehicle battery pack according to one or more embodiments of the present disclosure;

FIG. 3 illustrates a partial exploded view of a vehicle battery pack according to one or more embodiments of the present disclosure, showing a lower portion of the battery pack comprising a first battery cell;

FIG. 4 illustrates a partial exploded view of a vehicle battery pack according to one or more embodiments of the present disclosure, showing an upper portion of the battery pack comprising a second battery cell;

FIG. 5 illustrates a partial sectional view of a vehicle battery pack according to one or more embodiments of the present disclosure;

FIG. 6 illustrates a partial sectional view of a vehicle battery pack according to one or more embodiments of the present disclosure;

FIG. 7 illustrates a partial perspective view of a vehicle battery pack according to one or more embodiments of the present disclosure, showing a thermal isolation plate and busbar on a separator;

FIG. 8 illustrates a partial perspective view of a vehicle battery pack according to one or more embodiments of the present disclosure, further showing the structure of the separator;

FIG. 9 illustrates a partial sectional view of a vehicle battery pack according to one or more embodiments of the present disclosure, wherein a longitudinal section of an exhaust channel is shown;

FIG. 10 illustrates a partial sectional view of a vehicle battery pack according to one or more embodiments of the present disclosure, wherein a cross section of an exhaust channel is shown;

FIG. 11 illustrates a partial sectional view of a vehicle battery pack according to one or more embodiments of the present disclosure;

FIG. 12 illustrates a partial sectional view of a vehicle battery pack according to one or more embodiments of the present disclosure;

FIG. 13 illustrates a partial sectional view of a vehicle battery pack according to one or more embodiments of the present disclosure;

FIG. 14 illustrates a partial perspective view of a vehicle battery pack according to one or more embodiments of the present disclosure;

FIG. 15 illustrates a partial sectional view of a vehicle battery pack according to one or more embodiments of the present disclosure;

FIG. 16 illustrates a partial perspective view of a vehicle battery pack according to one or more embodiments of the present disclosure, wherein a cooling structure and connecting lines of the battery pack are shown; and

FIG. 17 illustrates a partial sectional view of a vehicle battery pack according to one or more additional embodiments of the present disclosure.

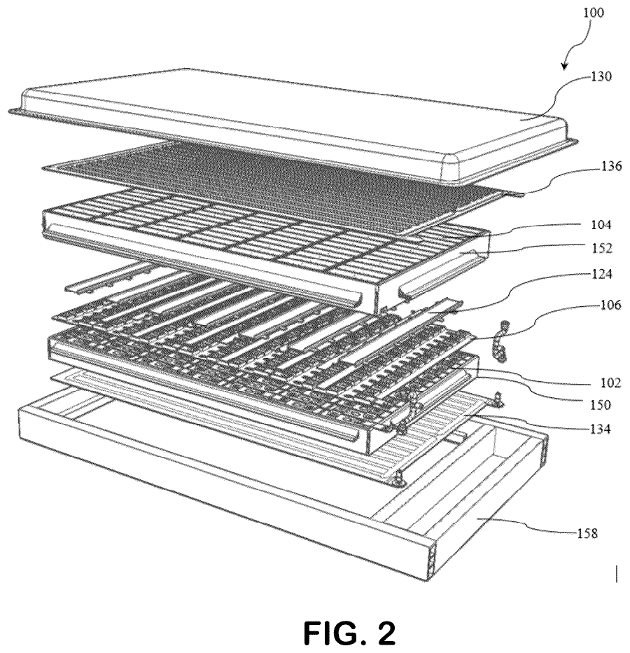

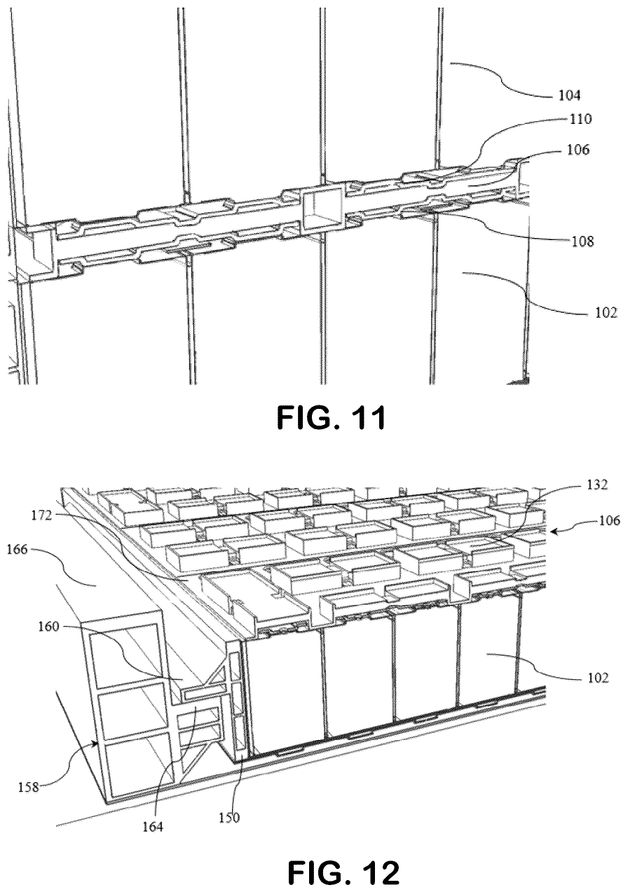

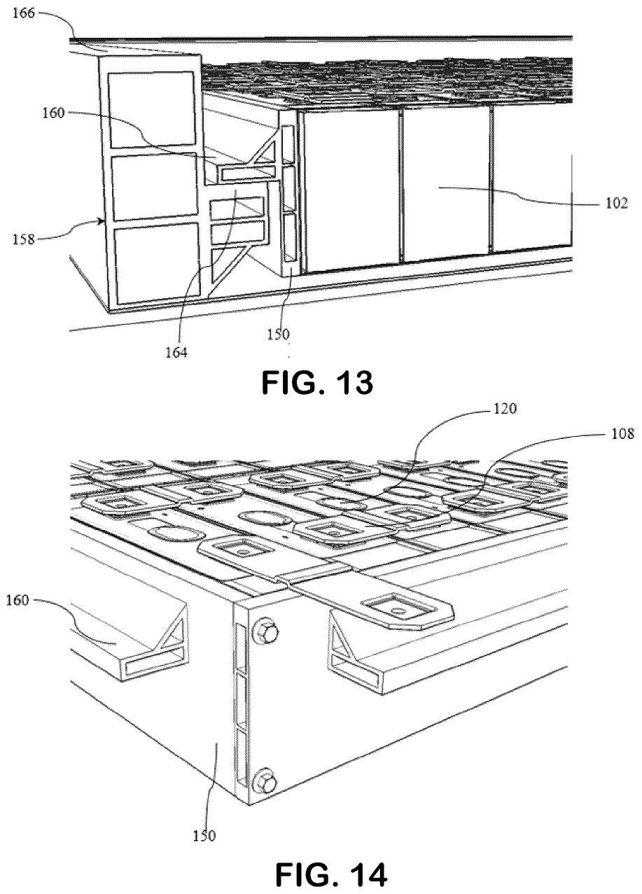

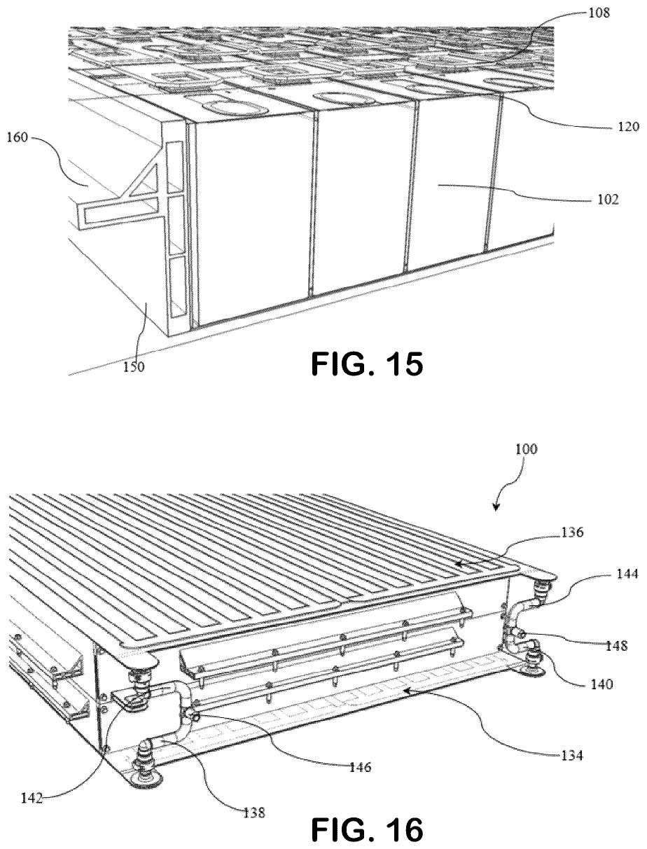

FIGS. 2-17 are drawn to scale.

### DETAILED DESCRIPTION

The present disclosure is related to systems for a battery pack and summarizes aspects of the embodiments and should not be used to limit the claims. Other implementations are contemplated in accordance with the techniques described herein, as will be apparent to those skilled in the art upon examination of the following drawings and detailed description, and such implementations are intended to be within the scope of this application.

The inventors of the present application have recognized the demand for a vehicle battery pack and a vehicle having such a battery pack that can further affect space utilization efficiency, simplify the overall structure, provide higher electricity capacity within limited space, and simultaneously reduce production resources, thereby enhancing user satisfaction.

An aspect of the present disclosure provides a vehicle battery pack including a first battery cell, a second battery cell, and a separator located between the first battery cell and the second battery cell, wherein the first battery cell and the second battery cell have positive and negative electrode terminals both oriented towards the separator.

According to an embodiment of the present disclosure, each of the first battery cell and the second battery cell includes a cell exhaust port toward the separator, and the separator at least partially shapes an exhaust channel of the cell exhaust port.

According to an embodiment of the present disclosure, each of the first battery cell and the second battery cell includes a busbar, and the separator at least partially accommodates the busbars of the first battery cell and the second battery cell and electrically isolates the first battery cell and the second battery cell.

According to an embodiment of the present disclosure, the vehicle battery pack further includes a second separator located between the separator and the second battery cell, wherein the second separator is provided with a busbar opening at least partially corresponding to the busbar of the second battery cell, the separator is provided with a first opening corresponding to a cell exhaust port of the first battery cell, and the second separator is provided with a second opening corresponding to a cell exhaust port of the second battery cell.

According to an embodiment of the present disclosure, the vehicle battery pack further comprises a thermal isolation plate extending through opposite sides of the first battery cell and the second battery cell, wherein the thermal isolation plate, the separator, and the second separator enclosedly form an exhaust channel connecting the cell exhaust ports.

According to an embodiment of the present disclosure, the thermal isolation plate separates the cell exhaust port of the first battery cell and the cell exhaust port of the second battery cell. The thermal isolation plate and the separator enclosedly form a first exhaust channel connecting the cell exhaust port of the first battery cell. The thermal isolation plate and the second separator enclosedly form a second exhaust channel connecting the cell exhaust port of the second battery cell.

According to an embodiment of the present disclosure, the vehicle battery pack further includes a battery pack top cover located above the first battery cell and the second battery cell and a plurality of exhaust valves located on the battery pack top cover, wherein each exhaust valve of the plurality of exhaust valves corresponds to an end of the exhaust channel.

According to an embodiment of the present disclosure, the separator is provided with a plurality of positioning grooves for at least partially accommodating the busbars.

According to an embodiment of the present disclosure, the second battery cell is located above the first battery cell.

According to an embodiment of the present disclosure, the vehicle battery pack further includes a first cooling plate located below the first battery cell and a second cooling plate located above the second battery cell. The first cooling plate includes a first coolant inlet manifold and a first coolant outlet manifold. The second cooling plate includes a second coolant inlet manifold and a second coolant outlet manifold, the first coolant inlet manifold and the second coolant inlet manifold are connected to a coolant inlet header, and the first coolant outlet manifold and the second coolant outlet manifold are connected to a coolant outlet header.

According to an embodiment of the present disclosure, the vehicle battery pack further includes a first cell frame that presses and supports the first battery cell from a first side, a second cell frame that presses and supports the second battery cell from a second side, a first isolation plate placed between the first battery cell and the first cell frame, and a second isolation plate placed between the second battery cell and the second cell frame.

According to an embodiment of the present disclosure, the vehicle battery pack further includes a battery tray frame, wherein the first cell frame and the second cell frame are both supported on and fixed to the battery tray frame.

According to an embodiment of the present disclosure, the vehicle battery pack further includes a first wing plate projecting outward from the first cell frame, and a second wing plate projecting outward from the second cell frame, wherein the first wing plate and the second wing plate are supported on and bolted to the battery tray frame.

According to an embodiment of the present disclosure, the vehicle battery pack further includes a frame convex beam projecting inward from the battery tray frame, wherein the first wing plate is supported on and bolted to the frame convex beam.

According to an embodiment of the present disclosure, the vehicle battery pack further includes a battery pack top cover located above the first battery cell and the second battery cell, wherein the battery tray frame comprises a top surface, and the battery pack top cover and the second wing plate are both supported on and connected to the top surface.

According to an embodiment of the present disclosure, the vehicle battery pack further includes a flexible sampling board for collecting information about each battery cell, wherein the separator and the second separator are provided with a wire opening for allowing wires connecting the battery cell and the flexible sampling board to pass through.

According to an embodiment of the present disclosure, the separator includes a number of separator units positioned side by side.

According to an embodiment of the present disclosure, the busbar of the first battery cell is welded to the first battery cell, and the busbar of the second battery cell is pressed against the second battery cell by gravity.

Another aspect of the present disclosure also provides a vehicle battery pack including a first array including a plurality of first battery cells disposed side by side, with a busbar of the first battery cell facing vertically upwards, a second array comprising a plurality of second battery cells disposed side by side, with a busbar of the second battery cell facing vertically downwards, and a separator between the first array and the second array, wherein the separator secures and accommodates the busbars of the first battery cells and the busbars of the second cells and electrically isolates the first battery cells from the second battery cells.

Yet another aspect of the present disclosure also provides a vehicle including a vehicle battery pack as any one of the above embodiments.

Embodiments of the present disclosure are described below. However, it is to be understood that the disclosed embodiments are merely examples and other embodiments may take various and alternative forms. Some features may be exaggerated or minimized to show details of particular components. Therefore, specific structural and functional details disclosed herein are not to be interpreted as limiting, but merely as a representative basis for teaching one skilled in the art to variously employ the present disclosure. As will be understood by those of ordinary skill in the art, various features shown and described with reference to any one figure may be combined with features shown in one or more other figures to produce embodiments not expressly shown or described. The combinations of features shown herein provide representative embodiments for typical disclosures. However, various combinations and modifications of the features consistent with the teachings of the present disclosure may be desired for certain particular applications or implementations.

In this application document, when an element or part is referred to as being “on . . . ”, “bonded to”, “connected to”, or “coupled to” another element or part, the element or part can be directly on another element or part, can be bonded, connected or coupled to another element or part, or there may be intervening elements or parts. In contrast, when an element is referred to as being “directly on . . . ”, “directly bonded to”, “directly connected to”, or “directly coupled to” another element or part, the intervening elements or parts may not be present. Other words used to describe the relationship between elements should be interpreted in a like fashion.

As mentioned in the background, the inventors recognize that there is still room for further optimization in solutions of the multilayer battery pack. A vehicle battery pack that can further affect the efficiency of space use and simplify the overall structure is needed, which should provide higher power based on limited space and reduce production resources, thus increasing user satisfaction.

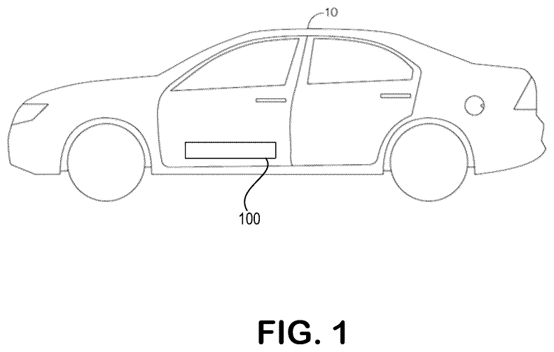

Turning now to FIG. 1, it illustrates a schematic diagram of a vehicle 10 comprising a vehicle battery pack 100 according to one or more embodiments of the present disclosure. It should be understood that in the context of the present disclosure, the vehicle 10 implementing the present disclosure may refer to any vehicle containing a vehicle battery pack, such as, but not limited to internal combustion engine (ICE) vehicles, electric vehicles (such as plug-in hybrid electric vehicles (PHEVs), fully hybrid electric vehicles (FHEVs), light hybrid electric vehicles (MHEVs), or battery electric vehicles (BEVs)), or even ships, aircraft, etc. The vehicle 10 may include components related to mobility, such as an engine, an electric motor, a transmission, a suspension, a drive shaft, and/or wheels, and the like. The vehicle 10 may be non-autonomous, semi-autonomous (e. g., some conventional motion functions autonomously controlled by the vehicle) or autonomous (e. g., motion functions autonomously controlled by the vehicle without direct input from the user).

In view of the aforementioned technical issues, one aspect of the present disclosure provides a battery pack 100. Generally referring to FIGS. 2 to 16, which may be described in tandem herein, the vehicle battery pack 100 comprises a first battery cell 102, a second battery cell 104, and a separator 106. The separator 106 is located between the first battery cell 102 and the second battery cell 104. The first battery cell 102 has positive and negative electrode terminals 174. The second battery cell 104 has positive and negative electrode terminals 176. Both the positive and negative electrode terminals 174 and the positive and negative electrode terminals 176 may be oriented toward the separator 106. In one example, the positive and negative electrode terminals 174 are arranged on a first side of the separator 106 and the positive and negative electrode terminals 176 are arranged on a second side of the separator 106, the first side opposite the second side.

Those skilled in the art should understand that in the context of the present disclosure, directional terms such as “above”, “below”, “front”, “rear”, “side”, “top” and “bottom” mentioned in the preceding and following disclosures are related to the battery pack in the installed state and the vehicle it is installed on. For example, the term “above” may generally correspond to the vertical upward direction of the vehicle 10 to which the vehicle battery pack 100 is installed. the term “below” generally corresponds to the vertical downward direction of the vehicle 10, and so on. Additionally or alternatively, the vertical direction may correspond to a direction of gravity, wherein the vertical downward direction is identical to the direction of gravity. Thus, the vertical upward direction is opposite the direction of gravity. The statement in this disclosure that “the positive and negative electrode terminals 174 and the positive and negative electrode terminals 176 are oriented toward the separator 106” refers to the fact that the surface where the positive and negative electrode terminals of the first battery cell 102 and the second battery cell 104 are located is closer to the separator 106 compared to the opposite surface without electrode terminals. The separator 106 electrically isolates or insulates the first battery cell 102 and the second battery cell 104. In some embodiments, the surface where the positive and negative electrode terminals are located may be parallel to the adjacent partition of the separator 106. And other angles may also be adopted in other embodiments.

In an embodiment of the present disclosure, the separator 106 is provided with the positive and negative electrode terminals 174 of the first battery cell 102 and the positive and negative electrode terminals 176 of the second battery cell 104, both oriented toward the separator 106. In the structure of the battery pack 100, the positive and negative terminals of the battery cells on both sides of the separator 106 are oriented towards the separator 106, which allows the additional structure of the battery cells on both sides (such as electric isolation structure, electrical connection structure, sampling structure, etc.) to be fully integrated or shared, providing a compact structure, further affecting the space utilization efficiency and thus user satisfaction.

Referring to FIGS. 2, 3 and 4, they show additional embodiments of the present disclosure. The vehicle battery pack 100 may be arranged in a double layer structure where the second battery cell 104 is positioned above the first battery cell 102. Thus, the battery cells located in the upper and lower layers may share the middle separator 106, which addresses the space utilization efficiency inside the battery pack. In the illustrated example, the battery cells located in the upper layer may cover all the battery cells located in the lower layer in a fully double layer structure. In other embodiments, the battery cells located in the upper layer may cover only some of the battery cells located in the lower layer in a partially double layer structure. In some further embodiments, the battery cells located in the upper layer may be positioned obliquely above the battery cells located in the lower layer. Further, in some embodiments, the first battery cell 102 and the second battery cell 104 may be a rectangular lithium-ion cell or a prismatic lithium-ion cell. The positive and negative electrode terminals 176 of the battery cell may be located on the same side (e.g., the first side) of the battery cell. However, within the scope of the present disclosure, a battery cell having other geometries (e.g., cylindrical, pocket shape, etc.), other chemical substances (nickel metal hydride, lead acid, etc.), or a combination thereof may be used instead.

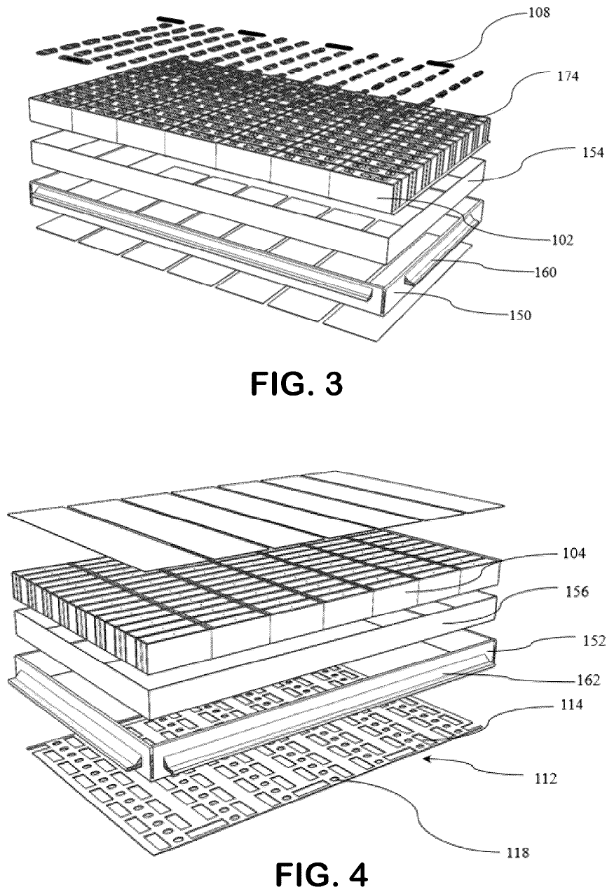

Referring further to FIGS. 3 and 4, the vehicle battery pack 100 may also include a first cell frame 150, a second cell frame 152, a first isolation plate 154, and a second isolation plate 156. The first cell frame 150 is pressed from the side and supports the first battery cell 102. The second cell frame 152 is pressed from the side and supports the second battery cell 104. The first isolation plate 154 is between the first battery cell 102 and the first cell frame 150. The second isolation plate 156 is between the second battery cell 104 and the second cell frame 152. The arrangement of the first isolation plate 154 and the second isolation plate 156 facilitates the electrical isolation between the battery cell and its supporting structure. The first isolation plate 154 and the second isolation plate 156 may include any electrically insulated material such as, but is not limited to, PP (polypropylene), PC (polycarbonate), or the like.

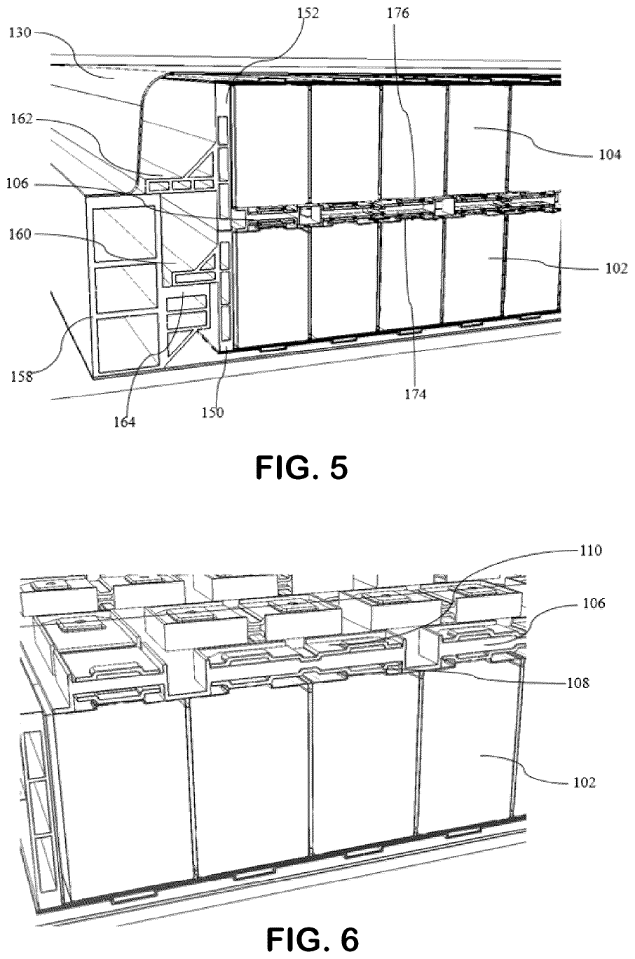

Referring to FIGS. 5 and 6, in some embodiments of the present disclosure, the first battery cell 102 includes a first busbar 108, and the second battery cell 104 comprises a second busbar 110. The separator 106 at least partially houses the first busbar 108 of the first battery cell 102 and the second busbar 110 of the second battery cell 104 and electrically isolates the first battery cell 102 and the second battery cell 104. By realizing the fixation and accommodation of the first and second busbars 108 and 110 and the first battery cell 102 and the second battery cell 104, the electrical isolation and electrical connection structures of the first battery cell 102 and the second battery cell 104 may be fully integrated to affect the space utilization. Further, the separator 106 may include any electrical insulating material, such as, but not limited to, PP (polypropylene), PC (polycarbonate), or the like.

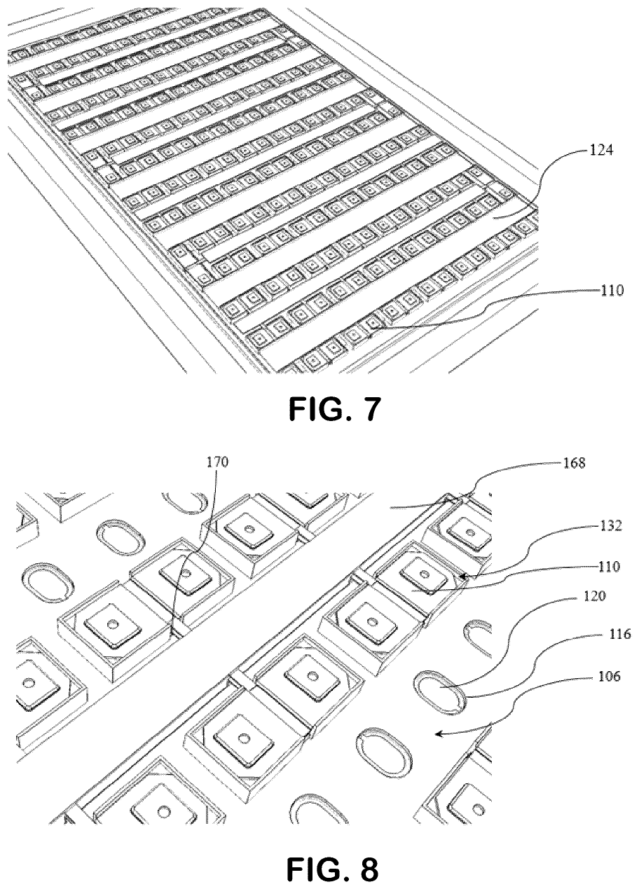

Referring to FIGS. 7 and 8, the separator 106 is provided with a number of positioning grooves 132 for at least partially accommodating the busbars 108 and 110. For example, the positioning grooves 132 that match the shape of the busbars 108 and 110 may be provided on both sides (e.g., the first side and the second side) of the separator 106. This enables the accurate positioning and fixation of the busbars 108 and 110.

Now referring to FIGS. 5, 6, 7, and 8, according to some embodiments of the present disclosure, the first busbar 108 of the first battery cell 102 is connected to the first battery cell 102 by welding. The second busbar 110 of the second battery cell 104 is pressed to the second battery cell 104 by gravity. During the assembly of the battery pack 100, the second battery cell 104 and the second busbar 110 do not need to be connected by welding. Instead, the second battery cell 104 may be placed upside down on the second busbar 110, thereby achieving electrical connection through the squeezing effect generated by the gravity of the second battery cell 104 itself, saving the corresponding installation process and production resources.

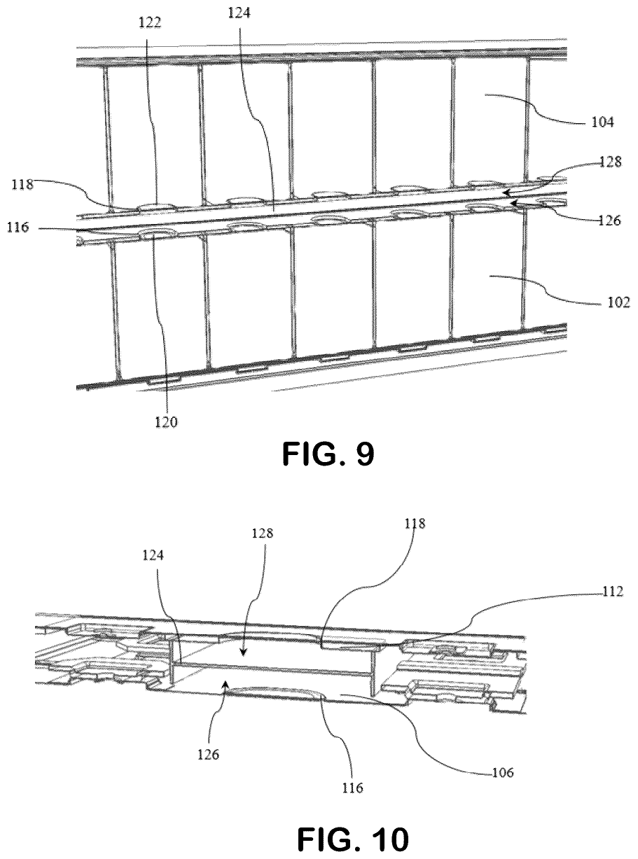

Referring to FIGS. 9 and 10, in some embodiments, the first battery cell 102 includes a first cell exhaust port 120. The second battery cell 104 includes a second cell exhaust port 122. Both cell exhaust ports 120 and 122 may face the separator 106. The separator 106 at least partially forms first and second exhaust channels 126 and 128 communicating with the first and second cell exhaust ports 120 and 122, respectively. The first and second exhaust channels 126 and 128 are connected to the first and second cell exhaust ports 120 and 122 to assist in the collection and discharge of the gas potentially produced by the battery cell during the operation.

Referring back to FIG. 4 and FIGS. 8 to 10, the vehicle battery pack 100 may also include a second separator 112 between the separator 106 and the second battery cell 104. The second separator 112 is provided with a busbar opening 114 at least partially corresponding to the busbar 110 of the second battery cell 104. The separator 106 (herein, interchangeably referred to as a first separator 106) has a first opening 116 corresponding to the first cell exhaust port 120 of the first battery cell 102. The second separator 112 has a second opening 118 corresponding to the second cell exhaust port 122 of the second battery cell 104. According to some embodiments of the present disclosure, during assembly of the vehicle battery pack 100, the second battery cell 104 is inverted and lifted, and the second battery separator 112 is then used to cover the battery high voltage portion of the second battery cell 104. The busbar 110 of the second battery cell 104 is disposed on the lower separator 106. When the second battery cell 104 is placed, the busbar 110 is electrically connected to the second battery cell 104 through the second opening 118 on the second separator 112 to facilitate assembly of the battery pack 100. At the same time, the first separator 106 and the second separator 112 are provided with a first opening 116 corresponding to the first cell exhaust port 120 of the first battery cell 102 and a second opening 118 corresponding to the second cell exhaust port 122 of the second battery cell 104 to assist in the collection and discharge of the gas potentially produced by the battery cell during the operation, for example, collecting into the first and second exhaust channels 126 and 128 and discharged. Additionally, according to the different structural needs, in some other embodiments, the first separator 106 and the second separator 112 may be integrated.

Referring to FIG. 8, in some embodiments of the present disclosure, the vehicle battery pack 100 also includes a flexible sampling board 168 for collecting information about each battery cell. A wire opening 170 is provided on the first separator 106 and the second separator 112 for allowing wires connecting the battery cell and the flexible sampling board 168 to pass through. Through the wire opening 170, the flexible sampling board 168 may collect information of the battery cells at any time, such as voltage, temperature, for transmission to the corresponding battery management system for management.

Continuing to FIGS. 9 and 10, the vehicle battery pack 100 also includes a thermal isolation plate 124 extending through the opposite sides of the first battery cell 102 and the second battery cell 104 (e.g., through the lateral sides of the battery pack 100). The thermal isolation plate 124 may be such as, but not limited to, a mica plate including silicate materials. The thermal isolation plate 124, the first separator 106 and the second separator 112 enclosedly form the first and second exhaust channels 126 and 128 connecting the first and second cell exhaust ports 120 and 122. Through the exhaust channels formed by the thermal isolation plate 124, the first separator 106 and the second separator 112, the gas potentially produced by the battery cell during the operation can be directed to the opposite sides of the first battery cell 102 and the second battery cell 104, i.e., the peripheral portion of the battery pack 100, and further discharged through the accessory structure (such as the exhaust valve) of the battery pack 100.

In a further embodiment of the present disclosure, as shown in the section views of FIGS. 9 and 10, the thermal isolation plate 124 separates the first cell exhaust port 120 of the first battery cell 102 from the second cell exhaust port 122 of the second battery cell 104. For example, the thermal isolation plate 124 is located between them in the vertical direction. The thermal isolation plate 124 and the first separator 106 enclosedly form the first exhaust channel 126 connecting the first cell exhaust port 120 of the first battery cell 102. The thermal isolation plate 124 and the second separator 112 enclosedly form the second exhaust channel 128 connecting the second cell exhaust port 122 of the second battery cell 104. In some embodiments, the cross-sectional shape of the thermal isolation plate 124 may be H-shaped as shown in FIG. 10. In this embodiment, the thermal isolation plate 124 separates the first cell exhaust port 120 from the second cell exhaust port 122 and forms two generally independent exhaust channels 126 and 128, reducing the possibility that the gas discharged from the battery cell directly affects the opposite battery cell. In one example, each of the first cell exhaust port 120 and the second cell exhaust port 122 includes a plurality of cell exhaust ports.

Further, returning to FIGS. 2 and 5, the vehicle battery pack 100 may also include a battery pack top cover 130 above the first battery cell 102 and the second battery cell 104. The battery pack top cover 130 is provided with a plurality of exhaust valves (not shown). An exhaust valve of the plurality of exhaust valves may correspond to an end of the first and second exhaust channels 126 and 128. For example, but not limited to, the end of each or several exhaust channels 126 and 128 may be adjacent to or below a corresponding exhaust valve on the battery pack top cover 130. This configuration facilitates the rapid discharge of gas generated by the first battery cell 102 and the second battery cell 104 from the vehicle battery pack 100. In other embodiments, the exhaust valve may also be located on the battery tray, or on both the battery tray and the top cover.

Now referring to FIG. 12 in conjunction with FIG. 5, the vehicle battery pack 100 may also include a battery tray frame 158. The first cell frame 150 and the second cell frame 152 are both supported on and fixed to the battery tray frame 158. The battery tray frame 158 provides support for the weight of the battery cells through the first cell frame 150 and the second cell frame 152, which strengthens the overall structure of the battery pack 100.

In a further embodiment of the present disclosure, as shown in FIG. 5, and FIGS. 12 to 15, the vehicle battery pack 100 further includes a first wing plate 160 and a second wing plate 162. The first wing plate 160 projects outwardly from the first cell frame 150 and is connected to the first cell frame 150. The second wing plate 162 projects outwardly from the second cell frame 152 and is connected to the second cell frame 152. The first wing plate 160 and the second wing plate 162 are supported on and bolted to the battery tray frame 158. The wing plate protruding outward from the cell frame makes the support from the battery tray frame 158 for the weight of the battery cells more firm, increasing the overall structural stability, and the bolt connection further increases the connection convenience.

Furthermore, referring to FIGS. 12 to 14, the vehicle battery pack 100 may also include a frame convex beam 164 projecting inward from the battery tray frame 158. The first wing plate 160 is supported on and bolted to the frame convex beam 164. The frame beam 164 on the battery tray frame 158 provides a lower mounting position for the first wing plate 160 to affect the overall structural stability.

Returning to FIGS. 5 and 12, in some embodiments of the present disclosure, the battery tray frame 158 includes a top surface 166. The battery pack top cover 130 and the second wing plate 162 are both supported on and connected to the top surface 166. In this configuration, the battery pack top cover 130 shares the same mounting surface with the second wing plate 162 to reduce the overall structural complexity and assembly.

Now referring to FIG. 12, the first separator 106 may include a plurality of separator units 172 disposed side by side. In some embodiments, each separator unit of the plurality of separator units 172 may extend through the opposite sides of the first battery cell 102 and the second battery cell 104, such as through both sides of the whole width or length direction of the first battery cell 102 and the second battery cell 104. Further, in an embodiment where each separator unit of the plurality of separator units 172 runs through both sides of the whole length direction of the first battery cell 102 and second battery cell 104, a plurality of exhaust valves may be provided on both sides of the length direction. In an embodiment where each separator unit of the plurality of separator units 172 runs through both sides of the whole width direction of the first battery cell 102 and second battery cell 104, a plurality of exhaust valves may be provided on both sides of the width direction. That is, the first separator 106 may be assembled by a plurality of the separator units 172, each of which may extend in one direction throughout the entire battery pack. Of course, in other structures, the size of each separator unit of the plurality of separator units 172 may be adjusted as needed and arranged in an array arrangement. For example, multiple rows and columns of separator units are combined to form the entire separator. This construction facilitates the overall fabrication and assembly of the separator 106.

Next, referring to FIG. 16, the vehicle battery pack 100 may also include a first cooling plate 134 located below the first battery cell 102, and a second cooling plate 136 located above the second battery cell 104. The first cooling plate 134 includes a first coolant inlet manifold 138 and a first coolant outlet manifold 140 for feeding in and out of the coolant, respectively. The second cooling plate 136 includes a second coolant inlet manifold 142 and a second coolant outlet manifold 144 for feeding coolant in and out, respectively. The first coolant inlet manifold 138 and the second coolant inlet manifold 142 communicate to a coolant inlet header 146. The first coolant outlet manifold 140 and the second coolant outlet manifold 144 are connected to the coolant outlet header 148. In this structure, the first cooling plate 134 is connected in parallel with the second cooling plate 136, and the coolant from a coolant inlet header 146 is evenly distributed between the first cooling plate 134 and the second cooling plate 136, realizing cooling of the battery cells and circulation of the coolant, and finally flowing out from the coolant outlet header 148.

Further, in some embodiments of the present disclosure, aerogels may be provided between adjacent first battery cells 102 and between adjacent second battery cells 104 to absorb volume expansion generated during the operation of the battery cell.

Those skilled in the art may understand that the manufacturing materials for each component of the vehicle battery pack 100, as described above and below, may include but are not limited to various types of aluminum alloys, magnesium alloys, low, medium, and high carbon steels, as well as any other metal/non-metal or synthetic/composite materials, plastics, etc. Further, the processing and manufacturing of various components of the vehicle battery pack 100 may be achieved by extrusion, stamping, casting, molding, 3D printing, etc. Furthermore, the bonding or connection described above and below can be achieved by various alternative methods, for example, welding, bonding, jamming, riveting, thread connection, integral forming, etc., welding including, but not limited to, inert gas protection welding, laser welding, and the like.

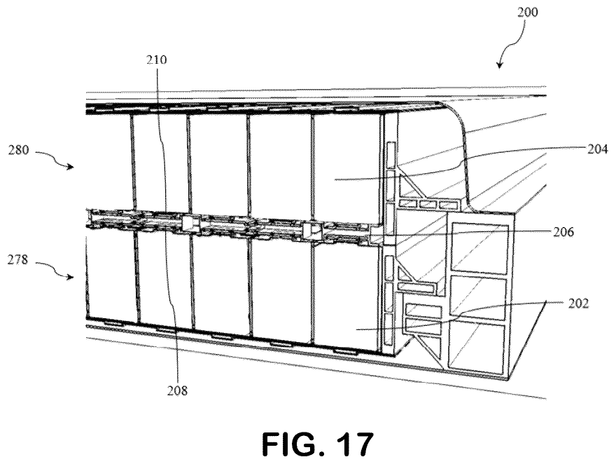

According to another aspect of the present disclosure, referring to FIG. 17, there is also provided a vehicle battery pack 200 comprising a first array 278, a second array 280, and a separator 206. The first array 278 comprises a plurality of first battery cells 202 positioned side by side, with a first busbar 208 of the first battery cell 202 facing vertically upwards. The second array 280 comprises a plurality of second battery cells 204 positioned side by side, with a second busbar 210 of the second battery cell 204 facing vertically downwards. The separator 206 is located between the first array 278 and the second array 280 for fixing and accommodating the first and second busbars 208 and 210 of the first battery cells 202 and the second battery cells 204, and electrically isolating the first battery cells 202 and the second battery cells 204. It should be understood that, all of the embodiments, features and advantages described above for the battery pack 100 according to the first aspect of the present disclosure may equally apply to the battery pack 200 according to another aspect of the present disclosure. That is, all the embodiments described above and their changes can be directly applied and combined here. For the sake of the brevity of this disclosure, it will not be repeated here.

In accordance with yet another aspect of the present disclosure, referring to FIG. 1, there is also provided a vehicle 10 having the vehicle battery pack 100 or 200 as described in any of the above embodiments. Likewise, it should be understood that without conflict, all the above embodiments, features and advantages described for the battery packs 100 and 200 according to the present disclosure equally apply to the vehicle 10 according to such another aspect of the present disclosure. That is, all the embodiments described above and their changes can be directly applied and combined here. For the sake of the brevity of this disclosure, it will not be repeated here.

The present disclosure proposes a vehicle battery pack and a vehicle with the battery pack. And the technical solution of the present disclosure can further affect the space utilization efficiency, simplify the overall structure, provide higher power based on limited space, and simultaneously reduce the production resources, thereby affecting user satisfaction.

The disclosure also provides support for a vehicle battery pack, comprising: a first battery cell, a second battery cell, and a separator located between the first battery cell and the second battery cell, wherein the first battery cell and the second battery cell comprise positive and negative electrode terminals both oriented towards the separator. In a first example of the system, each of the first battery cell and the second battery cell comprises a cell exhaust port facing the separator, wherein the separator at least partially forms an exhaust channel of the cell exhaust port. In a second example of the system, optionally including the first example, each of the first battery cell and the second battery cell comprises a busbar, and the separator at least partially accommodates the busbars of the first battery cell and the second battery cell and electrically isolates the first battery cell from the second battery cell. In a third example of the system, optionally including one or both of the first and second examples, the separator is a first separator, further comprising a second separator located between the first separator and the second battery cell, wherein the second separator is provided with a busbar opening at least partially corresponding to the busbar of the second battery cell, the first separator is provided with a first opening corresponding to a first cell exhaust port of the first battery cell, and the second separator is provided with a second opening corresponding to a second cell exhaust port of the second battery cell, wherein the first opening and the second opening are aligned along an axis. In a fourth example of the system, optionally including one or more or each of the first through third examples, the system further comprises: a thermal isolation plate extending through opposite sides of the first battery cell and the second battery cell, wherein the thermal isolation plate, the first separator, and the second separator enclosedly form an exhaust channel connecting a plurality of first cell exhaust ports or a plurality of second cell exhaust ports. In a fifth example of the system, optionally including one or more or each of the first through fourth examples, the thermal isolation plate separates the first cell exhaust port of the first battery cell from the second cell exhaust port of the second battery cell, the thermal isolation plate and the first separator enclosedly form a first exhaust channel coupled to the first cell exhaust port of the first battery cell, and wherein the thermal isolation plate and the second separator enclosedly form a second exhaust channel coupled to the second cell exhaust port of the second battery cell. In a sixth example of the system, optionally including one or more or each of the first through fifth examples, the system further comprises: a battery pack top cover located above the first battery cell and the second battery cell and a plurality of exhaust valves located on the battery pack top cover, wherein an exhaust valve of the plurality of exhaust valves corresponds to an end of an exhaust channel. In a seventh example of the system, optionally including one or more or each of the first through sixth examples, the separator is provided with a number of positioning grooves for at least partially accommodating the busbars. In an eighth example of the system, optionally including one or more or each of the first through seventh examples, the second battery cell is located above the first battery cell. In a ninth example of the system, optionally including one or more or each of the first through eighth examples, the system further comprises: a first cooling plate located below the first battery cell and a second cooling plate located above the second battery cell, wherein the first cooling plate comprises a first coolant inlet manifold and a first coolant outlet manifold, the second cooling plate comprises a second coolant inlet manifold and a second coolant outlet manifold, the first coolant inlet manifold and the second coolant inlet manifold are connected to a coolant inlet header, and the first coolant outlet manifold and the second coolant outlet manifold are connected to a coolant outlet header. In a tenth example of the system, optionally including one or more or each of the first through ninth examples, the system further comprises: a first cell frame that presses and supports the first battery cell from side, a second cell frame that presses and supports the second battery cell from side, a first isolation plate placed between the first battery cell and the first cell frame, and a second isolation plate placed between the second battery cell and the second cell frame. In a eleventh example of the system, optionally including one or more or each of the first through tenth examples, the system further comprises: a battery tray frame, wherein the first cell frame and the second cell frame are both supported on and fixed to the battery tray frame. In a twelfth example of the system, optionally including one or more or each of the first through eleventh examples, the system further comprises: a first wing plate projecting outward from the first cell frame, and a second wing plate projecting outward from the second cell frame, wherein the first wing plate and the second wing plate are supported on and bolted to the battery tray frame. In a thirteenth example of the system, optionally including one or more or each of the first through twelfth examples, the system further comprises: a frame convex beam projecting inward from the battery tray frame, wherein the first wing plate is supported on and bolted to the frame convex beam. In a fourteenth example of the system, optionally including one or more or each of the first through thirteenth examples, the system further comprises: a battery pack top cover located above the first battery cell and the second battery cell, wherein the battery tray frame comprises a top surface, and the battery pack top cover and the second wing plate are both supported on and connected to the top surface. In a fifteenth example of the system, optionally including one or more or each of the first through fourteenth examples, the system further comprises: a flexible sampling board for collecting information about each battery cell, wherein the separator and the second separator are provided with a wire opening for allowing wires connecting the battery cell and the flexible sampling board to pass through. In a sixteenth example of the system, optionally including one or more or each of the first through fifteenth examples, the separator comprises a number of separator units positioned side by side. In a seventeenth example of the system, optionally including one or more or each of the first through sixteenth examples, the busbar of the first battery cell is welded to the first battery cell, and the busbar of the second battery cell is pressed against the second battery cell by gravity.

The disclosure also provides support for a vehicle battery pack, comprising: a first array comprising a plurality of first battery cells disposed side by side, with a busbar of the first battery cell facing vertically upwards, a second array comprising a plurality of second battery cells disposed side by side, with a busbar of the second battery cell facing vertically downwards, and a separator between the first array and the second array, wherein the separator secures and accommodates the busbars of the first battery cells and the busbars of the second battery cells and electrically isolates the first battery cells from the second battery cells.

The disclosure also provides support for a system for a battery pack, comprising: a first battery cell, a second battery cell, a first separator located between the first battery cell and the second battery cell, wherein the first battery cell and the second battery cell comprise positive and negative electrode terminals both oriented towards the separator, a second separator located between the first separator and the second battery cell, wherein the second separator is provided with a busbar opening at least partially corresponding to the busbar of the second battery cell, the first separator is provided with a first opening corresponding to a first cell exhaust port of the first battery cell, and the second separator is provided with a second opening corresponding to a second cell exhaust port of the second battery cell, wherein the first opening and the second opening are aligned along an axis, and a thermal isolation plate extending through opposite sides of the first battery cell and the second battery cell, wherein the thermal isolation plate, the first separator, and the second separator enclosedly form an exhaust channel connecting a plurality of first cell exhaust ports or a plurality of second cell exhaust ports.

It should be understood that, on the premise of technical feasibility, the technical features listed above for different embodiments can be combined with each other to form other embodiments within the scope of the present disclosure.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively.

The above-mentioned embodiments are possible examples of implementations of the present disclosure and are given only for the purpose of enabling those skilled in the art to clearly understand the principles of the present invention. It should be understood by those skilled in the art that the above discussion to any embodiment is only illustrative, and is not intended to imply that the disclosed scope of the embodiments of the present disclosure (including claims) is limited to these examples; and under the overall concept of the present invention, the technical features in the above embodiments or different embodiments can be combined with each other to produce many other changes in different aspects of embodiments of the present invention that is not provided in detailed description for the sake of brevity. Therefore, any omission, modification, equivalent replacement, etc. made within the spirit and principle of the embodiment of the present invention shall be included in the scope of protection claimed by the present invention.

FIGS. 1-17 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. It will be appreciated that one or more components referred to as being “substantially similar and/or identical” differ from one another according to manufacturing tolerances (e.g., within 1-5% deviation).

It will be appreciated that the configurations and routines disclosed herein are exemplary in nature, and that these specific embodiments are not to be considered in a limiting sense, because numerous variations are possible. The subject matter of the present disclosure includes all novel and non-obvious combinations and sub-combinations of the various systems and configurations, and other features, functions, and/or properties disclosed herein.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A battery pack, comprising:
a first battery cell;
a second battery cell; and
a separator located between the first battery cell and the second battery cell;
wherein the first battery cell and the second battery cell comprise positive and negative electrode terminals both oriented towards the separator.

2. The battery pack of claim 1, wherein each of the first battery cell and the second battery cell comprises a cell exhaust port facing the separator, wherein the separator at least partially forms an exhaust channel of the cell exhaust port.

3. The battery pack of claim 1, wherein each of the first battery cell and the second battery cell comprises a busbar, and the separator at least partially accommodates the busbar of the first battery cell and the busbar the second battery cell and electrically isolates the first battery cell from the second battery cell.

4. The battery pack of claim 1, wherein the separator is a first separator, further comprising a second separator located between the first separator and the second battery cell, wherein the second separator is provided with a busbar opening at least partially corresponding to the busbar of the second battery cell, the first separator is provided with a first opening corresponding to a first cell exhaust port of the first battery cell, and the second separator is provided with a second opening corresponding to a second cell exhaust port of the second battery cell, wherein the first opening and the second opening are aligned along an axis.

5. The battery pack of claim 4, further comprising a thermal isolation plate extending through opposite sides of the first battery cell and the second battery cell, wherein the thermal isolation plate, the first separator, and the second separator enclosedly form an exhaust channel connecting a plurality of first cell exhaust ports or a plurality of second cell exhaust ports.

6. The battery pack of claim 5, wherein the thermal isolation plate separates the first cell exhaust port of the first battery cell from the second cell exhaust port of the second battery cell, the thermal isolation plate and the first separator enclosedly form a first exhaust channel coupled to the first cell exhaust port of the first battery cell, and wherein the thermal isolation plate and the second separator enclosedly form a second exhaust channel coupled to the second cell exhaust port of the second battery cell.

7. The battery pack of claim 1, further comprising a battery pack top cover located above the first battery cell and the second battery cell and a plurality of exhaust valves located on the battery pack top cover, wherein an exhaust valve of the plurality of exhaust valves corresponds to an end of an exhaust channel.

8. The battery pack of claim 3, wherein the separator is provided with a number of positioning grooves for at least partially accommodating the busbar of the first battery cell and the busbar of the second battery cell.

9. The battery pack of claim 1, wherein the second battery cell is located above the first battery cell.

10. The battery pack of claim 9, further comprising a first cooling plate located below the first battery cell and a second cooling plate located above the second battery cell, wherein the first cooling plate comprises a first coolant inlet manifold and a first coolant outlet manifold, the second cooling plate comprises a second coolant inlet manifold and a second coolant outlet manifold, the first coolant inlet manifold and the second coolant inlet manifold are connected to a coolant inlet header, and the first coolant outlet manifold and the second coolant outlet manifold are connected to a coolant outlet header.

11. The battery pack of claim 1, further comprising a first cell frame that presses and supports the first battery cell from side, a second cell frame that presses and supports the second battery cell from side, a first isolation plate placed between the first battery cell and the first cell frame, and a second isolation plate placed between the second battery cell and the second cell frame.

12. The battery pack of claim 11, further comprising a battery tray frame, wherein the first cell frame and the second cell frame are both supported on and fixed to the battery tray frame.

13. The battery pack of claim 12, further comprising a first wing plate projecting outward from the first cell frame, and a second wing plate projecting outward from the second cell frame, wherein the first wing plate and the second wing plate are supported on and bolted to the battery tray frame.

14. The battery pack of claim 13, further comprising a frame convex beam projecting inward from the battery tray frame, wherein the first wing plate is supported on and bolted to the frame convex beam.

15. The battery pack of claim 13, further comprising a battery pack top cover located above the first battery cell and the second battery cell, wherein the battery tray frame comprises a top surface, and the battery pack top cover and the second wing plate are both supported on and connected to the top surface.

16. The battery pack of claim 4, further comprising a flexible sampling board for collecting information about each battery cell, wherein the separator and the second separator are provided with a wire opening for allowing wires connecting the first battery cell or the second battery cell and the flexible sampling board to pass through.

17. The battery pack of claim 1, wherein the separator comprises a number of separator units positioned side by side.

18. The battery pack of claim 9, wherein the busbar of the first battery cell is welded to the first battery cell, and the busbar of the second battery cell is pressed against the second battery cell by gravity.

19. A battery pack, comprising:
a first array comprising a plurality of first battery cells disposed side by side, with a busbar of a first battery cell of the plurality of first battery cells facing vertically upwards;
a second array comprising a plurality of second battery cells disposed side by side, with a busbar of a second battery cell of the plurality of second battery cells facing vertically downwards; and
a separator between the first array and the second array, wherein the separator secures and accommodates a plurality of busbars of the first battery cells and the plurality of busbars of the second battery cells and electrically isolates the plurality of first battery cells from the plurality of second battery cells.

20. A system for a battery pack, comprising:
a first battery cell;
a second battery cell;
a first separator located between the first battery cell and the second battery cell;
wherein the first battery cell and the second battery cell comprise positive and negative electrode
terminals both oriented towards the separator;
a second separator located between the first separator and the second battery cell, wherein the second separator is provided with a busbar opening at least partially corresponding to the busbar of the second battery cell, the first separator is provided with a first opening corresponding to a first cell exhaust port of the first battery cell, and the second separator is provided with a second opening corresponding to a second cell exhaust port of the second battery cell, wherein the first opening and the second opening are aligned along an axis; and
a thermal isolation plate extending through opposite sides of the first battery cell and the second battery cell, wherein the thermal isolation plate, the first separator, and the second separator enclosedly form an exhaust channel connecting a plurality of first cell exhaust ports or a plurality of second cell exhaust ports.
